(19) United States
(12) Patent Application Publication
(10) Pub. No.: US 2025/0190810 A1
(43) Pub. Date: Jun. 12, 2025

(54) CONTINUAL NEURAL NETWORK TRAINING IN AN EDGE COMPUTING ENVIRONMENT

(71) Applicant: INTERNATIONAL BUSINESS MACHINES CORPORATION, ARMONK, NY (US)

(72) Inventors: ANDREW C. M. HICKS, HIGHLAND, NY (US); JOHN S. WERNER, FISHKILL, NY (US); RAFAELA FROTA, POUGHKEEPSIE, NY (US); FAEZEH GHOLAMI, RIDGEWOOD, NJ (US)

(21) Appl. No.: 18/536,390

(22) Filed: Dec. 12, 2023

(51) Int. Cl. G06N 3/096; G06N 3/098

(52) U.S. Cl. CPC G06N 3/096; G06N 3/098

(57) ABSTRACT

Continual neural network training in an edge computing environment includes deploying a plurality of copies of a centralized neural network respectively to a corresponding plurality of edge servers, wherein each of the copies of the centralized neural network is independently operated and trained at a respective one of the edge servers based on inputs received at that edge server to create independently trained neural networks. At periodic intervals, copies of the independently trained neural networks and a corresponding fitness measure for each of the copies of the independently trained neural networks are sent from the plurality of edge servers to a cloud-based data center. The centralized neural network is updated at the cloud-based data center, including performing neural network breeding based on the copies of the independently trained neural networks sent from the plurality of edge servers.

### BACKGROUND

The present disclosure relates to methods, apparatus, and products for continual neural network training in an edge computing environment.

### SUMMARY

According to embodiments of the present disclosure, various methods, apparatus and products for continual neural network training in an edge computing environment are described herein. In some aspects, continual neural network training in an edge computing environment includes deploying a plurality of copies of a centralized neural network respectively to a corresponding plurality of edge servers, wherein each of the copies of the centralized neural network is independently operated and trained at a respective one of the edge servers based on inputs received at that edge server to create independently trained neural networks. At periodic intervals, copies of the independently trained neural networks and a corresponding fitness measure for each of the copies of the independently trained neural networks are sent from the plurality of edge servers to a cloud-based data center. The centralized neural network is updated at the cloud-based data center, including performing neural network breeding based on the copies of the independently trained neural networks sent from the plurality of edge servers.

### BRIEF DESCRIPTION OF THE DRAWINGS

FIG. 1 sets forth an example computing environment according to aspects of the present disclosure.

FIG. 2 sets forth an example implementation of a system for continual neural network training in an edge computing environment according to aspects of the present disclosure.

FIG. 3 sets forth a flowchart of an example method for continual neural network training in an edge computing environment according to aspects of the present disclosure.

FIG. 4 sets forth a flowchart of an example method for updating a centralized neural network according to aspects of the present disclosure.

FIG. 5 sets forth a flowchart of an example method for continual neural network training in an edge computing environment according to another aspect of the present disclosure.

### DETAILED DESCRIPTION

Neural networks may be deployed in edge computing environments to increase bandwidth and reduce latency for end users. It may be useful to continuously train the neural network such that it keeps improving over time. Galápagos Syndrome is a business term that refers to an isolated development branch of a globally available product. An example is when neural networks are trained at edge systems, and one or more edge systems may drift and diverge from other edge systems (i.e., experience Galápagos Syndrome) causing unpredictable behavior for end users that may not always connect to the same edge system based on their physical location.

In many instances, it may be useful to maintain a single “centralized” neural network that is trained based on input from all edge servers. For example, if a neural network is utilized for visual recognition by autonomous vehicles, the visual data seen by a vehicle at a first edge server can help to train the centralized neural network to improve the visual recognition system for any autonomous vehicles connecting to a second edge server (based on the vehicles physical proximity to the server). In this example, it may not be beneficial for the neural network on the first edge server to train itself and not share data with the second edge server because the second edge server may eventually encounter similar input and generate an incorrect output to one or more vehicles which, in some instances, may lead to an accident, causing harm to passengers, pedestrians, and/or damaging the vehicle and its surroundings.

One option is to send all input from every edge server back to the centralized neural network on the cloud for further training, but this puts a large strain on the network and uses significant bandwidth. In some cloud deployments, if an edge server reaches its capacity, it will rely on upstream servers (e.g., cloud servers or fog nodes) to handle workload for the end users, and if the bandwidth is being used to send input data back to the cloud in addition to handling this workload, the end users may experience latency issues which could be catastrophic in some implementations (e.g., autonomous vehicles). There is a need for continuously updating a centralized neural network that is deployed to edge servers without putting significant strain on the network.

Some examples disclosed herein use NeuroEvolution of Augmenting Topologies (NEAT) for Galápagos Syndrome prevention in edge computing environments, and update and maintain a common centralized neural network running on separate edge nodes without putting strain on the network that could cause latency and bandwidth problems. Some examples operate individual neural networks on one or more edge servers and allow those individual neural networks to train themselves at the edge using only the inputs seen at their edge server. The individual edge neural networks may begin to differ from one another. At periodic intervals (e.g., once per day, once per week, etc.), the individual edge neural networks are sent back to a cloud data center along with their corresponding fitness measurements where neural network breeding occurs to update a centralized neural network. The updated centralized neural network is then deployed back to each of the one or more edge servers. This method may then be repeated such that continuous training and updating of the centralized neural network occurs without sending any input data back to the cloud data center which considerably reduces network bandwidth. Some examples may be implemented as a service (aaS) for deployment of artificial intelligence (AI) in edge computing environments.

An example of the present disclosure is directed to a method for continual neural network training in an edge computing environment, including deploying a plurality of copies of a centralized neural network respectively to a corresponding plurality of edge servers, wherein each of the copies of the centralized neural network is independently operated and trained at a respective one of the edge servers based on inputs received at that edge server to create independently trained neural networks. The method includes sending, at periodic intervals, copies of the independently trained neural networks and a corresponding fitness measure for each of the copies of the independently trained neural networks from the plurality of edge servers to a cloud-based data center. The method includes updating the centralized neural network at the cloud-based data center, including performing neural network breeding based on the copies of the independently trained neural networks sent from the plurality of edge servers.

Examples of the method include various technical features that yield technical effects that provide various improvements to computer technology. For instance, some examples include the technical feature of deploying a plurality of copies of a centralized neural network respectively to a corresponding plurality of edge servers, wherein each of the copies of the centralized neural network is independently operated and trained at a respective one of the edge servers based on inputs received at that edge server to create independently trained neural networks. This technical feature yields the technical effect of continually training the neural network such that it keeps improving over time. Some examples include the technical features of sending, at periodic intervals, copies of the independently trained neural networks and a corresponding fitness measure for each of the copies of the independently trained neural networks from the plurality of edge servers to a cloud-based data center; and updating the centralized neural network at the cloud-based data center, including performing neural network breeding based on the copies of the independently trained neural networks sent from the plurality of edge servers. These technical features yield the technical effect of preventing Galápagos Syndrome in which one or more edge servers may drift and diverge from other edge servers causing unpredictable behavior, while also reducing network traffic, improving network performance, and reducing power consumption.

The method may also include deploying a plurality of copies of the updated centralized neural network respectively to the plurality of edge servers. This has the technical effect of allowing the neural network to be continually trained and improved over time based on inputs at the edge servers, while also preventing drift among the edge servers.

In some examples of the method, updating the centralized neural network is performed without sending any of the inputs received at the edge servers to the cloud-based data center. This has the technical effect of helping to prevent strain on the network that may cause bandwidth and latency issues.

In some examples of the method, the periodic interval is defined by a preset period of time. This has the technical effect of preventing Galápagos Syndrome using a preset period of time for updates that may be set by an administrator, for example. This provides flexibility for the timing of updates and network usage.

In some examples of the method, the periodic interval is defined by a preset amount of drift occurring in one or more of the copies of the independently trained neural networks. This has the technical effect of preventing Galápagos Syndrome using a preset amount of drift for updates that may be set by an administrator, for example. This helps to ensure that there is not significant drift between updates.

In some examples of the method, the neural network breeding includes discarding any of the copies of the independently trained neural networks sent from the plurality of edge servers that have a corresponding fitness measure below a threshold. This has the technical effect of improving the performance of the updating by discarding any of the copies of the independently trained neural networks that have a relatively low fitness measure.

In some examples of the method, the neural network breeding includes selecting top performing ones of the copies of the independently trained neural networks sent from the plurality of edge servers based on the fitness measures. This has the technical effect of improving the performance of the updating by selecting and using top performing ones of the copies of the independently trained neural networks.

In some examples of the method, the neural network breeding includes performing a hyperNEAT calculation that includes determining a weighted average, based on the fitness measures, of parameters extracted from neurons in one or more of the copies of the independently trained neural networks sent from the plurality of edge servers. This has the technical effect of improving the performance of the updating by using a weighted average based on the fitness measures so that higher fitness measures may provide a greater influence.

Another example of the present disclosure is directed to an apparatus for continual neural network training in an edge computing environment, which includes a processing device, and a memory operatively coupled to the processing device. The memory stores computer program instructions that, when executed, cause the processing device to deploy a plurality of copies of a centralized neural network respectively to a corresponding plurality of edge servers, wherein each of the copies of the centralized neural network is independently operated and trained at a respective one of the edge servers based on inputs received at that edge server to create independently trained neural networks. The memory also stores computer program instructions that, when executed, cause the processing device to send, at periodic intervals, copies of the independently trained neural networks and a corresponding fitness measure for each of the copies of the independently trained neural networks from the plurality of edge servers to a cloud-based data center. The memory also stores computer program instructions that, when executed, cause the processing device to update the centralized neural network at the cloud-based data center, including performing neural network breeding based on the copies of the independently trained neural networks sent from the plurality of edge servers.

Examples of the apparatus include various technical features that yield technical effects that provide various improvements to computer technology. For instance, some examples include the technical feature of deploying a plurality of copies of a centralized neural network respectively to a corresponding plurality of edge servers, wherein each of the copies of the centralized neural network is independently operated and trained at a respective one of the edge servers based on inputs received at that edge server to create independently trained neural networks. This technical feature yields the technical effect of continually training the neural network such that it keeps improving over time. Some examples include the technical features of sending, at periodic intervals, copies of the independently trained neural networks and a corresponding fitness measure for each of the copies of the independently trained neural networks from the plurality of edge servers to a cloud-based data center; and updating the centralized neural network at the cloud-based data center, including performing neural network breeding based on the copies of the independently trained neural networks sent from the plurality of edge servers. These technical features yield the technical effect of preventing Galápagos Syndrome in which one or more edge servers may drift and diverge from other edge servers causing unpredictable behavior, while also reducing network traffic, improving network performance, and reducing power consumption.

The memory of the apparatus may also store computer program instructions that, when executed, cause the processing device to deploy a plurality of copies of the updated centralized neural network respectively to the plurality of edge servers. This has the technical effect of allowing the neural network to be continually trained and improved over time based on inputs at the edge servers, while also preventing drift among the edge servers.

In some examples of the apparatus, updating the centralized neural network is performed without sending any of the inputs received at the edge servers to the cloud-based data center. This has the technical effect of helping to prevent strain on the network that may cause bandwidth and latency issues.

In some examples of the apparatus, the periodic interval is defined by a preset period of time. This has the technical effect of preventing Galápagos Syndrome using a preset period of time for updates that may be set by an administrator, for example. This provides flexibility for the timing of updates and network usage.

In some examples of the apparatus, the periodic interval is defined by a preset amount of drift occurring in one or more of the copies of the independently trained neural networks. This has the technical effect of preventing Galápagos Syndrome using a preset amount of drift for updates that may be set by an administrator, for example. This helps to ensure that there is not significant drift between updates.

In some examples of the apparatus, the neural network breeding includes discarding any of the copies of the independently trained neural networks sent from the plurality of edge servers that have a corresponding fitness measure below a threshold. This has the technical effect of improving the performance of the updating by discarding any of the copies of the independently trained neural networks that have a relatively low fitness measure.

In some examples of the apparatus, the neural network breeding includes selecting top performing ones of the copies of the independently trained neural networks sent from the plurality of edge servers based on the fitness measures. This has the technical effect of improving the performance of the updating by selecting and using top performing ones of the copies of the independently trained neural networks.

In some examples of the apparatus, the neural network breeding includes performing a hyperNEAT calculation that includes determining a weighted average, based on the fitness measures, of parameters extracted from neurons in one or more of the copies of the independently trained neural networks sent from the plurality of edge servers. This has the technical effect of improving the performance of the updating by using a weighted average based on the fitness measures so that higher fitness measures will provide a greater influence.

Another example of the present disclosure is directed to a computer program product for continual neural network training in an edge computing environment, comprising a computer readable storage medium, wherein the computer readable storage medium comprises computer program instructions that, when executed deploy a plurality of copies of a centralized neural network respectively to a corresponding plurality of edge servers, wherein each of the copies of the centralized neural network is independently operated and trained at a respective one of the edge servers based on inputs received at that edge server to create independently trained neural networks; send, at periodic intervals, copies of the independently trained neural networks and a corresponding fitness measure for each of the copies of the independently trained neural networks from the plurality of edge servers to a cloud-based data center; and update the centralized neural network at the cloud-based data center, including performing neural network breeding based on the copies of the independently trained neural networks sent from the plurality of edge servers.

Examples of the computer program product include various technical features that yield technical effects that provide various improvements to computer technology. For instance, some examples include the technical feature of deploying a plurality of copies of a centralized neural network respectively to a corresponding plurality of edge servers, wherein each of the copies of the centralized neural network is independently operated and trained at a respective one of the edge servers based on inputs received at that edge server to create independently trained neural networks. This technical feature yields the technical effect of continually training the neural network such that it keeps improving over time. Some examples include the technical features of sending, at periodic intervals, copies of the independently trained neural networks and a corresponding fitness measure for each of the copies of the independently trained neural networks from the plurality of edge servers to a cloud-based data center; and updating the centralized neural network at the cloud-based data center, including performing neural network breeding based on the copies of the independently trained neural networks sent from the plurality of edge servers. These technical features yield the technical effect of preventing Galápagos Syndrome in which one or more edge servers may drift and diverge from other edge servers causing unpredictable behavior, while also reducing network traffic, improving network performance, and reducing power consumption.

In some examples of the computer program product, the computer readable storage medium may further comprise computer program instructions that, when executed, deploy a plurality of copies of the updated centralized neural network respectively to the plurality of edge servers. This has the technical effect of allowing the neural network to be continually trained and improved over time based on inputs at the edge servers, while also preventing drift among the edge servers.

In some examples of the computer program product, updating the centralized neural network is performed without sending any of the inputs received at the edge servers to the cloud-based data center. This has the technical effect of helping to prevent strain on the network that may cause bandwidth and latency issues.

In some examples of the computer program product, the neural network breeding includes performing a hyperNEAT calculation that includes determining a weighted average, based on the fitness measures, of parameters extracted from neurons in one or more of the copies of the independently trained neural networks sent from the plurality of edge servers. This has the technical effect of improving the performance of the updating by using a weighted average based on the fitness measures so that higher fitness measures will provide a greater influence.

Some examples of the present disclosure are directed to a method for Galápagos Syndrome prevention and network traffic reduction in edge computing environments, which includes operating individual neural networks on one or more edge servers. The method includes training, on each of the one or more edge servers, each individual neural network based on inputs seen at the edge server where the individual neural network is operating. The method includes sending, at periodic intervals, the individual neural networks operating on the one or more edge servers back to a cloud data center along with corresponding fitness measurements. The method includes breeding the individual neural networks to update a centralized neural network. The method includes deploying the updated centralized neural network to the one or more edge servers.

In some examples of the method, each edge server may contain one individual neural network. Each individual neural network may have a corresponding fitness measurement. In some examples of the method, no input data seen at any of the one or more edge servers is sent to the cloud data center. The periodic interval may be set by a network administrator. The periodic interval may be triggered when a preset amount of drift has occurred in one or more of the individual neural networks. The neural network breeding may discard edge neural networks with fitness measures below a threshold. The neural network breeding may select only the top performing edge neural networks based on their fitness measures. The neural network breeding may be performed using a hypercube-based NEAT (hyperNEAT) calculation which performs a weighted average, based on the fitness measure, of the parameters extracted from each neuron.

Some examples of the present disclosure use unsupervised models and unsupervised learning. Some examples provide minimization of data congestion within an edge computing environment to improve network performance. Some examples use fitness measurements at edge compute nodes to breed edge neural networks and redeploy an optimized neural network to each edge server. Some examples optimize deployment of a single trained neural network across multiple edge nodes without sending all training data seen at the edge nodes back to the centralized server which could put significant strain on a network. This strain would increase latency and increase power of all nodes back to the centralized location. Some examples save on power of systems used to support an edge network.

The centralized neural network may be initially built using a random neural network to simulate a computer brain, and then actions may be assigned to the neural network. The actions may include, for example, running testcases selected from existing regression buckets. The neural network may then be executed, and activation maps strengthened, and the state of a system under test may be checked. The system state may be evaluated after each test with a corresponding fitness score, ranking its performance on categories such as memory utilization or I/O throughput. Multiple neural networks may be operated (e.g., operating on separate edge servers), and a fitness score may be calculated for each. The top number or percentage of neural networks based on fitness scores may be selected for breeding and mutation in order to continue to refine the neural networks' test performance and ability to increase its fitness score. Over many genomes (iterations of breeding), the neural network will learn the system and may organically search out and test software, learning from all new testcases and regression buckets available and created in the future.

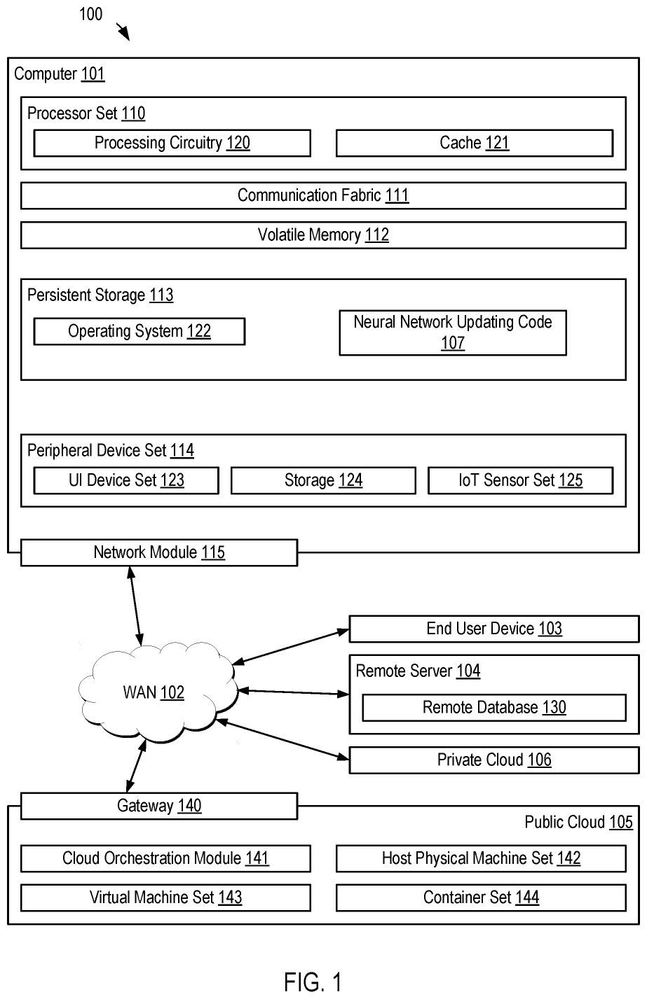

FIG. 1 sets forth an example computing environment according to aspects of the present disclosure. Computing environment 100 contains an example of an environment for the execution of at least some of the computer code involved in performing the various methods described herein, such as neural network updating code 107. In addition to neural network updating code 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and neural network updating code 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in neural network updating code 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in neural network updating code 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

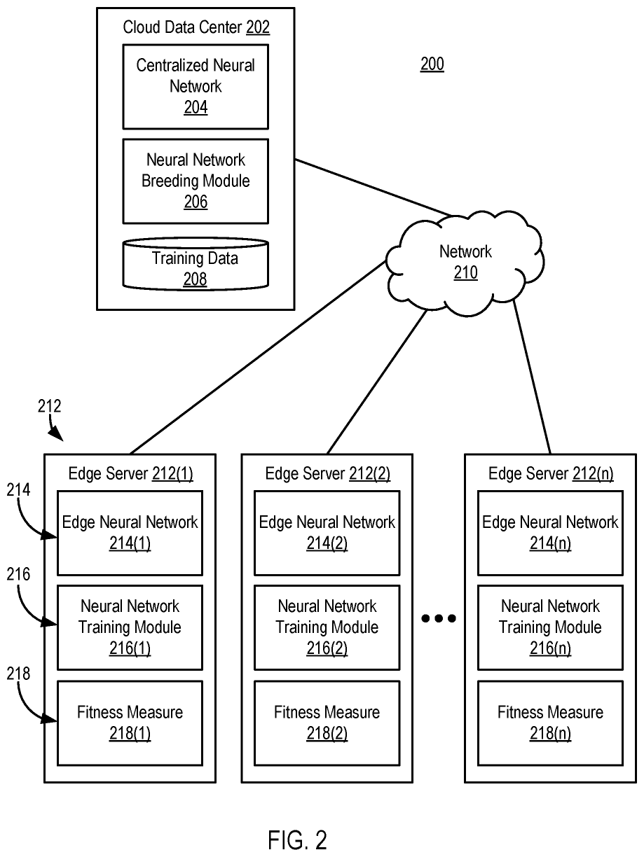

FIG. 2 sets forth an example implementation of a system 200 for continual neural network training in an edge computing environment according to aspects of the present disclosure. System 200 includes cloud data center 202, and a plurality of edge servers 212(1)-212(n) (collectively referred to as edge servers 212). Cloud data center 202 is communicatively coupled to the edge servers 212 via network 210. Network 210 may be a wired or wireless network, and may use any communication protocol that allows data to be transferred between components of the system 200, including, for example, PCIe, I2C, Bluetooth, Wi-Fi, Cellular (e.g., 3G, 4G, 5G), Ethernet, fiber optics, as well as others. Network 210 may also include fog nodes.

Cloud data center 202 includes centralized neural network 204, neural network breeding module 206, and training data 208. Cloud data center 202 may include one or more computing devices (e.g., servers, compute nodes, etc.), which may be scattered among one or more different physical locations. Edge servers 212(1)-212(n) respectively include edge neural networks 214(1)-214(n) (collectively referred to as edge neural networks 214), neural network training modules 216(1)-216(n) (collectively referred to as neural network training modules 216), and fitness measures 218(1)-218(n) (collectively referred to as fitness measures 218), which are respectively associated with edge neural networks 214(1)-214(n). In an example, neural network updating code 107 (FIG. 1) includes neural network breeding module 206 and neural network training modules 216. Edge servers 212 may be deployed in different physical locations such that the operations can be performed closer to end users of the system. Edge neural networks 214 receive inputs from end users (e.g., edge devices) and supply corresponding outputs to the end users.

Cloud data center 202 deploys copies of the centralized neural network 204 to the edge servers 212, which store their copies as edge neural networks 214. The centralized neural network 204 may be continuously trained and improved and repeatedly redeployed to the edge servers 212 without putting strain on the network 210. In an example, the centralized neural network 204 is initially built and trained at the cloud data center 202 using training data 208 during development, and is then updated on a periodic basis using neural network breeding module 206. The periodicity of the updates to the centralized neural network 204 may be dependent on use case (e.g., once per day, once per week, etc.). When the periodic time limit is reached, neural network breeding module 206 requests, from each of the edge servers 212, the current edge neural networks 214 and their associated fitness measures 218. The neural network breeding module 206 then performs a breeding operation between all of the received edge neural networks 214 to update the centralized neural network 204 before it is redeployed to each of the edge servers 212 and stored as edge neural networks 214.

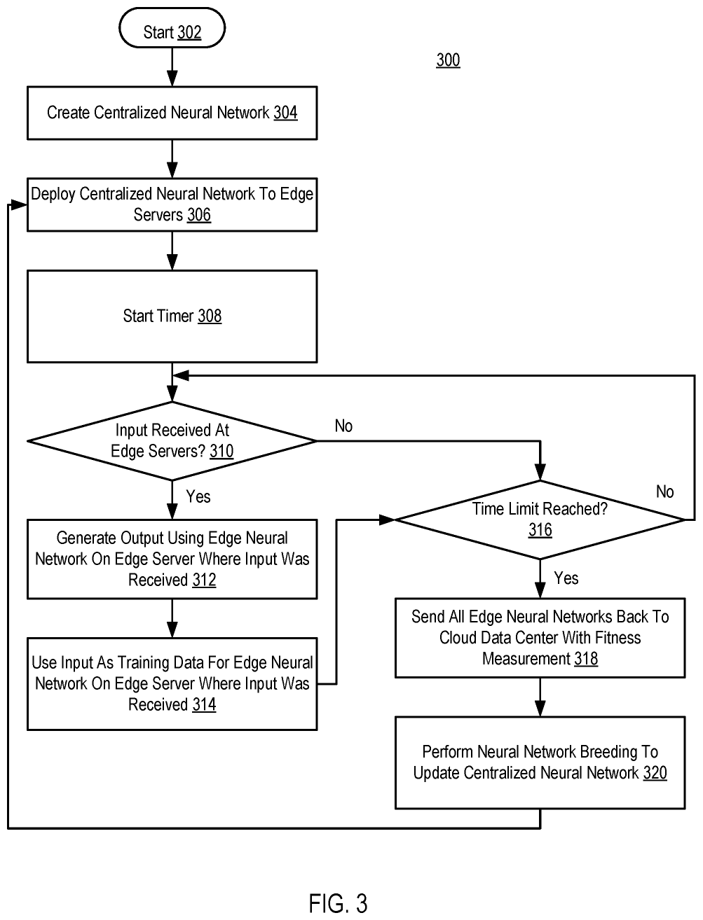

Between each update and redeployment of the centralized neural network 204 to the edge servers 212 by the cloud data center 202, the edge neural networks 214 operate independently from each other and are trained and updated by their respective neural network training modules 216 based on the inputs seen at their respective edge servers 212. Each of the neural network training modules 216 determines a fitness measure 218 for its associated edge neural network 214. Each of the fitness measures 218 provides a measure of performance of its associated edge neural network 214. The fitness measures 218 may be updated continuously by the neural network training modules 216 as the edge neural networks 214 are trained and updated at the edge servers 212. In some examples, the fitness measures 218 may include memory allocation, input/output (I/O) through-put, score in a game, obtaining a system error, as well as others. The system 200 shown in FIG. 2 is described in further detail below with reference to FIG. 3.

FIG. 3 sets forth a flowchart of an example method 300 for continual neural network training in an edge computing environment according to aspects of the present disclosure. In a particular embodiment, the method 300 of FIG. 3 is performed by system 200 (FIG. 2) utilizing the neural network updating code 107, which includes neural network breeding module 206 and neural network training modules 216. The method 300 of FIG. 3 starts at 302, and includes creating 304 a centralized neural network. In some examples, the centralized neural network in method 300 may be centralized neural network 204 that is initially created within cloud data center 202 using training data 208. The method 300 further includes deploying 306 the centralized neural network to a plurality of edge servers. In some examples, cloud data center 202 deploys the most updated version of the centralized neural network 204 at 306 in method 300, and the edge servers in method 300 may be edge servers 212, which may each store a received copy of the centralized neural network as edge neural network 214. The method 300 further includes starting 308 a timer. In some examples, neural network breeding module 206 starts the timer in method 300, and the timer sets the duration before the edge neural networks 214 are sent back to the cloud data center 202 to update the centralized neural network 204 prior to redeployment. The timer limit or duration may be set by a system administrator based on how often they want the edge neural networks updated (e.g., 1 day, 1 week, 1 month, etc.). In an alternate embodiment, instead of using a timer, a preset amount of drift may be set at 308 for any one of the deployed edge neural networks 214 that indicates a maximum amount of allowable drift before neural network breeding should be performed by neural network breeding module 206.

The method 300 further includes determining, at 310, whether input has been received at any of the edge servers. In some examples, each of the edge servers 212 operates independently and waits for input from edge devices (e.g., Internet of Things (IoT) devices, autonomous vehicles, mobile devices, etc.) to be processed by their edge neural networks 214. If it is determined at 310 that input has been received at the edge servers, the method 300 moves to 312, which includes generating 312 output using the edge neural network on the edge server where the input was received. In some examples, the output is provided to the edge device that provided the input to the edge server. The method 300 further includes using 314 the input as training data for the edge neural network on the edge server where the input was received, and the method 300 moves to 316. In some examples, the neural network training module 216 on the edge server 212 where the input was received uses that input as training data for the edge neural network 214 on that edge server 212 in method 300, and updates the corresponding fitness measure 218. The neural network training module 216 may use reinforcement learning, back-propagation, or other methods for the training. Because only the edge neural network that received the input is being trained and updated based on that input, the edge neural networks may begin to drift and differ from one another.

If it is determined at 310 that input has not been received at the edge servers, the method 300 moves to 316, which includes determining whether a specified time limit has been reached. In some examples, neural network breeding module 206 monitors the timer started at 308 and makes the determination at 316. If it is determined at 316 that the time limit has not been reached, the method 300 returns to 310 to again determine whether input has been received at the edge servers. Thus, the edge neural networks are allowed to continue to operate, train, and update independently. In embodiments where a preset amount of drift is set at 308 instead of a timer, the determination at 316 may check the amount of drift experienced between the current version of the trained edge neural networks 214 and the last version of the deployed centralized neural network 204 to determine if the threshold drift has been reached on one or more edge neural networks 214 of edge servers 212.

If it is determined at 316 that the time limit has been reached, the method 300 moves to 318, which includes sending all edge neural networks back to a cloud data center with fitness measurements. In some examples, neural network breeding module 206 notifies the edge servers 212 at 318 when the time limit has been reached, and in response, the edge servers 212 send their respective edge neural networks 214 and their associated fitness measures 218 to the cloud data center 202. In some examples, instead of using a preset time limit, a preset amount of drift in one or more of the edge neural networks may be used. Minimal bandwidth is utilized when sending edge neural networks and their fitness measures back to the cloud data center as compared to the amount of data that would be consumed if all inputs (e.g., potentially millions of datapoints in some applications) seen at the edge servers were sent.

The method 300 further includes performing 320 neural network breeding to update the centralized neural network, and then the method 300 returns to 306 to deploy the updated centralized neural network to the edge servers. In some examples, neural network breeding module 206 performs the breeding in method 300 to update the centralized neural network 204. In some examples, previous versions of the centralized neural network and/or the edge neural networks may be stored such that they can be redeployed if desired.

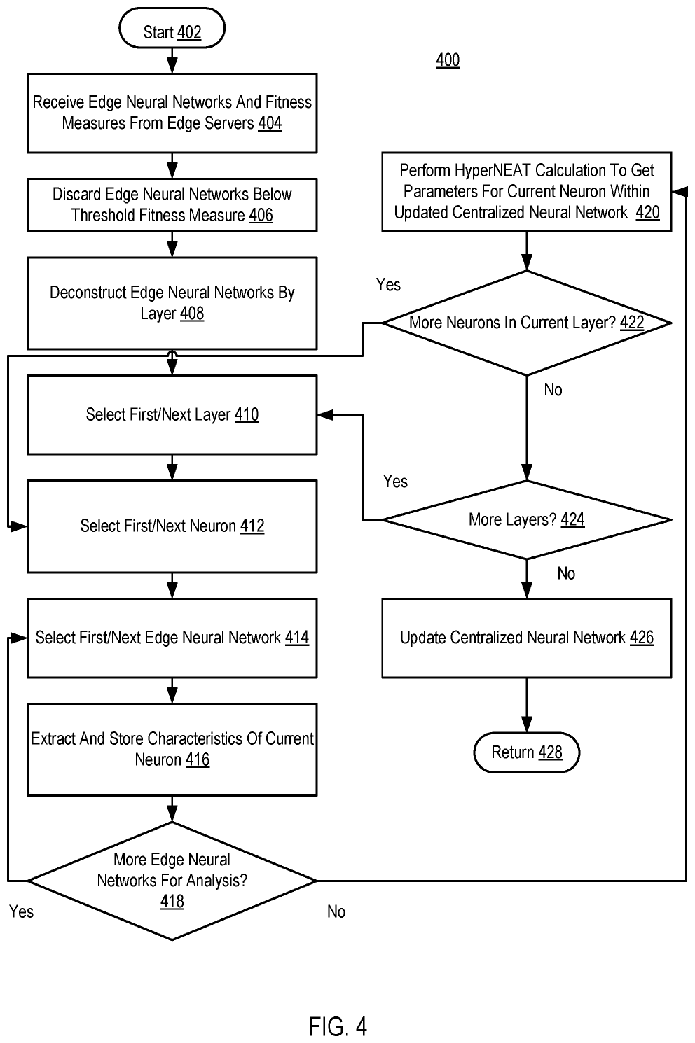

FIG. 4 sets forth a flowchart of an example method 400 for updating a centralized neural network according to aspects of the present disclosure. In a particular embodiment, the method 400 of FIG. 4 is performed utilizing the neural network breeding module 206, which is part of the neural network updating code 107, and which, in some examples, performs breeding of all edge neural networks 214 to update and redeploy the centralized neural network 204. The method 400 may be implemented as part of the breeding at 320 in method 300. The method 400 of FIG. 4 starts at 402, and includes receiving 404 edge neural networks and fitness measures from edge servers. In an example, neural network breeding module 206 receives edge neural networks 214 and fitness measures 218 from edge servers 212. It is noted that this action puts significantly less strain on network 210 as opposed to sending all data received at each edge server 212 back to the cloud data center 202 for training of the centralized neural network 204.

The method 400 further includes discarding 406 edge neural networks with an associated fitness measure that is below a threshold fitness measure. In some examples, the method 400 may include the cloud data center 202 querying the edge servers 212 for the fitness measures 218 prior to 404 in method 400 such that only the edge neural networks 214 with high fitness measures (e.g., above the threshold) are sent over the network 210 to the cloud data center 202, which further reduces traffic on the network 210. In some examples, rather than using a threshold at 406 in method 400, the method 400 may select the top “m” (e.g., top 3, top 5, etc.) fitness measures for breeding of their associated edge neural networks.

The method 400 further includes deconstructing 408 edge neural networks by layer. In some examples, the method 400 may alternatively decouple the entire set of layers into an array and then iterate through the list, rather than using nested loops as shown in FIG. 4. The method 400 further includes selecting 410 a first/next layer in the edge neural networks being analyzed. During the first pass through the selecting at 410, a first layer in the edge neural networks is selected, and during subsequent passes, other layers in the edge neural networks are selected. An iteration loop begins/continues at 410 in method 400 by selecting the first/next layer that will be analyzed. For example, if the edge neural networks 214 have 10 layers, then the method 400 will iterate through all 10 layers, one at a time. In some examples, all of the edge neural networks 214 have the same structure (i.e., same number of layers and same number of neurons within each layer). From layer to layer, the number of neurons may differ (e.g., all the edge neural networks 214 may have 5 neurons in layer 1, 7 neurons in layer 2, etc.). In some examples, one or more of the edge neural networks 214 have a different structure (i.e., different number of layers and/or different number of neurons within each layer). In these examples, the HyperNEAT calculation at 420 may include performing a weighted average of only similar neurons between the neural networks being breeded and those new neurons may be added to the updated neural network at that edge node.

The method 400 further includes selecting 412 a first/next neuron in the selected layer of the edge neural networks. During the first pass through the selecting at 412, a first neuron in the selected layer is selected, and during subsequent passes, other neurons in the selected layer are selected. A nested loop begins/continues at 412 in method 400 where the first/next neuron within the currently selected layer is selected for analysis. For example, if layer 1 contains 5 neurons in all of the edge neural networks 214, the method 400 will iterate through all 5, one at a time.

The method 400 further includes selecting 414 a first/next edge neural network. Another nested loop begins/continues at 414 in method 400 where the first/next edge neural network is selected for analysis. For example, if there are 5 edge neural networks 214 in system 200, the method 400 will iterate through all 5, one at a time.

The method 400 further includes extracting and storing 416 characteristics of the currently selected neuron. In some examples, the characteristics of the currently selected neuron within the currently selected layer within the currently selected edge neural network 214 may be extracted and stored in a data structure. The characteristics at 416 in method 400 may include weights, biases, activation functions, dependencies, etc.

At 418 in method 400, it is determined whether more edge neural networks are to be analyzed. If it is determined at 418 that there are more edge neural networks to be analyzed, the method 400 returns to 414 to select the next edge neural network to be analyzed. If it is determined at 418 that there are no more edge neural networks to be analyzed, the method 400 moves to 420.

The method 400 further includes performing 420 a HyperNEAT calculation to get parameters for the currently selected neuron in the currently selected layer within what will become an updated centralized neural network. In some examples, the HyperNEAT calculation at 420 involves performing a weighted average (based on fitness measure) of the parameters extracted from each neuron.

At 422 in method 400, it is determined whether there are more neurons in the currently selected layer to be analyzed. If it is determined at 422 that there are more neurons in the currently selected layer to be analyzed, the method 400 returns to 412 to select the next neuron. If it is determined at 422 that there are not more neurons in the currently selected layer to be analyzed, the method 400 moves to 424.

At 424 in method 400, it is determined whether there are more layers in the edge neural networks to be analyzed. If it is determined at 424 that there are more layers to be analyzed, the method 400 returns to 410 to select the next layer. If it is determined at 424 that there are not more layers to be analyzed, the method 400 moves to 426. The method 400 further includes updating 426 the centralized neural network. At 428, the method 400 may return to method 300 at 306, for example, to deploy the updated centralized neural network to all of the edge servers.

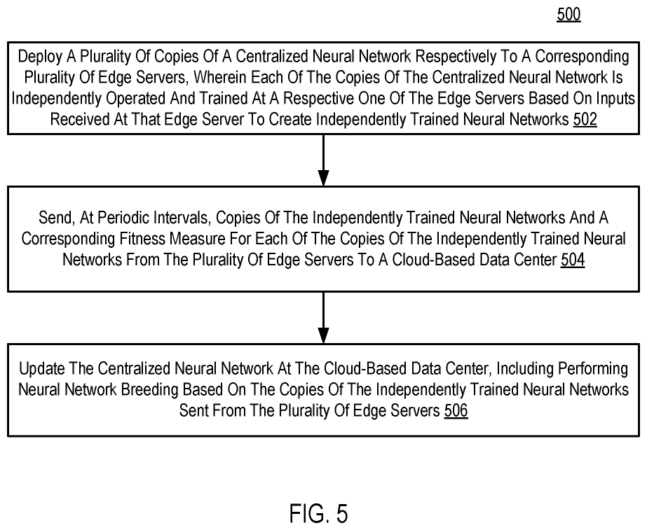

FIG. 5 sets forth a flowchart of an example method 500 for continual neural network training in an edge computing environment according to another aspect of the present disclosure. In a particular embodiment, the method 500 of FIG. 5 is performed by system 200 (FIG. 2) utilizing the neural network updating code 107, which includes neural network breeding module 206 and neural network training modules 216. The method 500 includes deploying 502 a plurality of copies of a centralized neural network respectively to a corresponding plurality of edge servers, wherein each of the copies of the centralized neural network is independently operated and trained at a respective one of the edge servers based on inputs received at that edge server to create independently trained neural networks. The method 500 further includes sending 504, at periodic intervals, copies of the independently trained neural networks and a corresponding fitness measure for each of the copies of the independently trained neural networks from the plurality of edge servers to a cloud-based data center. The method 500 further includes updating 506 the centralized neural network at the cloud-based data center, including performing neural network breeding based on the copies of the independently trained neural networks sent from the plurality of edge servers. In some examples, the method 500 may also include deploying a plurality of copies of the updated centralized neural network respectively to the plurality of edge servers.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for continual neural network training in an edge computing environment, comprising:
deploying a plurality of copies of a centralized neural network respectively to a corresponding plurality of edge servers, wherein each of the copies of the centralized neural network is independently operated and trained at a respective one of the edge servers based on inputs received at that edge server to create independently trained neural networks;
sending, at periodic intervals, copies of the independently trained neural networks and a corresponding fitness measure for each of the copies of the independently trained neural networks from the plurality of edge servers to a cloud-based data center; and
updating the centralized neural network at the cloud-based data center, including performing neural network breeding based on the copies of the independently trained neural networks sent from the plurality of edge servers.

2. The method of claim 1, and further comprising:
deploying a plurality of copies of the updated centralized neural network respectively to the plurality of edge servers.

3. The method of claim 1, wherein updating the centralized neural network is performed without sending any of the inputs received at the edge servers to the cloud-based data center.

4. The method of claim 1, wherein the periodic interval is defined by a preset period of time.

5. The method of claim 1, wherein the periodic interval is defined by a preset amount of drift occurring in one or more of the copies of the independently trained neural networks.

6. The method of claim 1, wherein the neural network breeding includes discarding any of the copies of the independently trained neural networks sent from the plurality of edge servers that have a corresponding fitness measure below a threshold.

7. The method of claim 1, wherein the neural network breeding includes selecting top performing ones of the copies of the independently trained neural networks sent from the plurality of edge servers based on the fitness measures.

8. The method of claim 1, wherein the neural network breeding includes performing a hyperNEAT calculation that includes determining a weighted average, based on the fitness measures, of parameters extracted from neurons in one or more of the copies of the independently trained neural networks sent from the plurality of edge servers.

9. An apparatus for continual neural network training in an edge computing environment, comprising:
a processing device; and
memory operatively coupled to the processing device, wherein the memory stores computer program instructions that, when executed, cause the processing device to:
deploy a plurality of copies of a centralized neural network respectively to a corresponding plurality of edge servers, wherein each of the copies of the centralized neural network is independently operated and trained at a respective one of the edge servers based on inputs received at that edge server to create independently trained neural networks;
send, at periodic intervals, copies of the independently trained neural networks and a corresponding fitness measure for each of the copies of the independently trained neural networks from the plurality of edge servers to a cloud-based data center; and
update the centralized neural network at the cloud-based data center, including performing neural network breeding based on the copies of the independently trained neural networks sent from the plurality of edge servers.

10. The apparatus of claim 9, wherein the memory stores computer program instructions that, when executed, cause the processing device to:
deploy a plurality of copies of the updated centralized neural network respectively to the plurality of edge servers.

11. The apparatus of claim 9, wherein updating the centralized neural network is performed without sending any of the inputs received at the edge servers to the cloud-based data center.

12. The apparatus of claim 9, wherein the periodic interval is defined by a preset period of time.

13. The apparatus of claim 9, wherein the periodic interval is defined by a preset amount of drift occurring in one or more of the copies of the independently trained neural networks.

14. The apparatus of claim 9, wherein the neural network breeding includes discarding any of the copies of the independently trained neural networks sent from the plurality of edge servers that have a corresponding fitness measure below a threshold.

15. The apparatus of claim 9, wherein the neural network breeding includes selecting top performing ones of the copies of the independently trained neural networks sent from the plurality of edge servers based on the fitness measures.

16. The apparatus of claim 9, wherein the neural network breeding includes performing a hyperNEAT calculation that includes determining a weighted average, based on the fitness measures, of parameters extracted from neurons in one or more of the copies of the independently trained neural networks sent from the plurality of edge servers.

17. A computer program product for continual neural network training in an edge computing environment, comprising a computer readable storage medium, wherein the computer readable storage medium comprises computer program instructions that, when executed:
deploy a plurality of copies of a centralized neural network respectively to a corresponding plurality of edge servers, wherein each of the copies of the centralized neural network is independently operated and trained at a respective one of the edge servers based on inputs received at that edge server to create independently trained neural networks;
send, at periodic intervals, copies of the independently trained neural networks and a corresponding fitness measure for each of the copies of the independently trained neural networks from the plurality of edge servers to a cloud-based data center; and
update the centralized neural network at the cloud-based data center, including performing neural network breeding based on the copies of the independently trained neural networks sent from the plurality of edge servers.

18. The computer program product of claim 17, wherein the computer readable storage medium further comprises computer program instructions that, when executed:
deploy a plurality of copies of the updated centralized neural network respectively to the plurality of edge servers.

19. The computer program product of claim 17, wherein updating the centralized neural network is performed without sending any of the inputs received at the edge servers to the cloud-based data center.

20. The computer program product of claim 17, wherein the neural network breeding includes performing a hyperNEAT calculation that includes determining a weighted average, based on the fitness measures, of parameters extracted from neurons in one or more of the copies of the independently trained neural networks sent from the plurality of edge servers.
